(19) United States
(12) Patent Application Publication
(10) Pub. No.: US 2020/0187014 A1
(43) Pub. Date: Jun. 11, 2020

(54) Managing Spectrum in Wireless Communication Network

(71) Applicant: VOLKAN SEVINDIK, PARKER, CO (US)

(72) Inventor: VOLKAN SEVINDIK, PARKER, CO (US)

(21) Appl. No.: 16/706,702

(22) Filed: Dec. 7, 2019

Related U.S. Application Data
(60) Provisional application No. 62/777,272, filed on Dec. 10, 2018.

(51) Int. Cl. H04W 16/14; H04W 28/26

(52) U.S. Cl. CPC H04W 16/14; H04W 28/26

(57) ABSTRACT

A method of managing spectrum in wireless communication network is disclosed. Local spectrum manager, and spectrum synchronizer are used to manage frequency spectrum utilization in a wireless communication network. Local spectrum manager grants, regrants, revokes spectrum to a node, nodes, to a cluster of nodes or to entire cluster of nodes in a wireless communication network. Spectrum synchronizer enables synchronization among local spectrum managers, and manages the utilization of frequency spectrum in entire network.

### CROSS REFERENCE TO A RELATED APPLICATION

This application claims the benefit of U.S. Provisional Application Ser. No. 62777272, filed 10 Dec. 2018, the disclosure of which is hereby incorporated by reference in its entirety, including all figures, tables, and drawings.

### BACKGROUND OF THE INVENTION

Unlicensed frequency spectrum is open to be used by 5G/New Radio technology and future wireless communication networks. Wireless operators currently use licensed spectrum and licensed spectrum is rented to a wireless operator through spectrum auctioning. Since wireless operators pay for the licensed spectrum, that cost is shared among users/subscribers of wireless network provider. On the contrary, unlicensed spectrum does not require any auctioning process or any payment to use the spectrum, and this makes wireless data and voice services more affordable. Subscriber's/users of wireless data and voices services will pay less. Therefore, innovation in this space is crucial to create much more affordable wireless data and voice services to anyone who is interested in consuming the service.

One of the main challenges of unlicensed spectrum access is management of unlicensed spectrum and distribution of spectrum resources among wireless service operators and also between wireless nodes/base stations of a wireless operator. Today, there are central mechanisms to manage the spectrum from a specific central location, however single point of failure and load management is a big issue since there are too many requests coming to a central location. Therefore, distributed spectrum management systems are proposed by industry practitioners in order to make spectrum management process more robust to outside attacks, and also distribute the task of managing spectrum to the whole network.

Distributed spectrum management systems manage unlicensed spectrum by assigning a certain chunk of frequency spectrum to a particular wireless node in a wireless network. Assigned spectrum is used by the wireless node for free of charge for a set duration of time, and this time is called ‘spectrum rent duration’ and after spectrum rent duration is over, assigned spectrum is revoked by the spectrum manager.

### BRIEF DESCRIPTION OF THE DRAWINGS

FIG. 1 shows hardware components for a node.

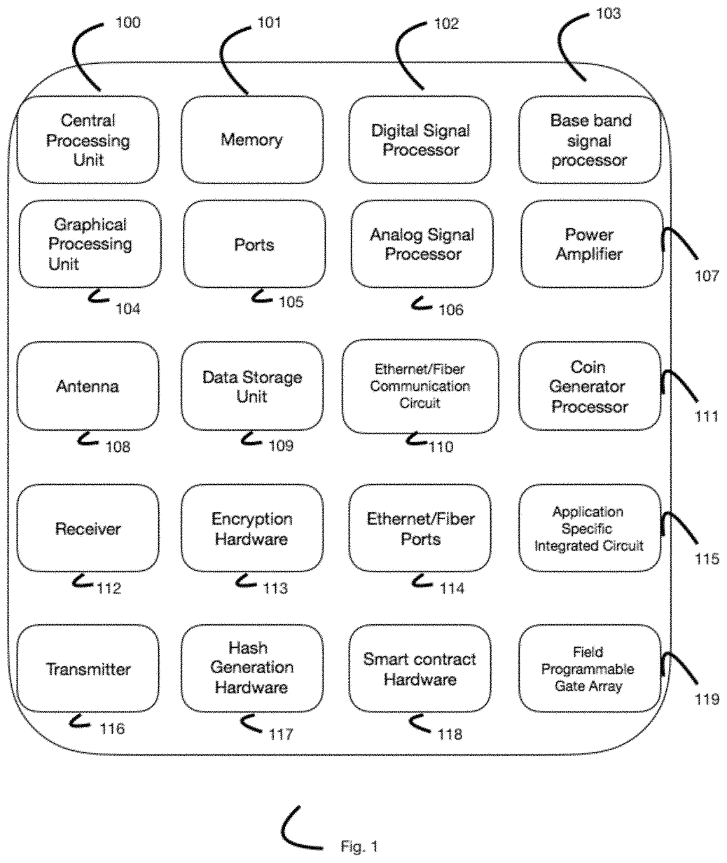

FIG. 2 shows user terminals, nodes, cluster of nodes, cluster, local spectrum managers, spectrum synchronizers, and communication link between and among them,

FIG. 3 shows spectrum synchronizer, local spectrum manager, and synchronizer connecting to the nearest local spectrum manager.

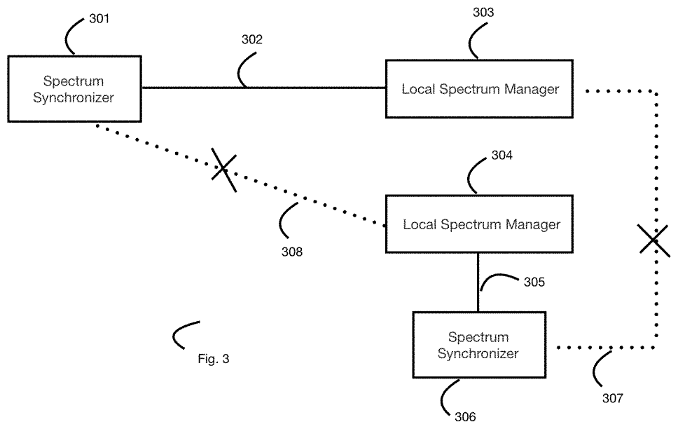

FIG. 4 shows tree architecture created starting with spectrum synchronizer.

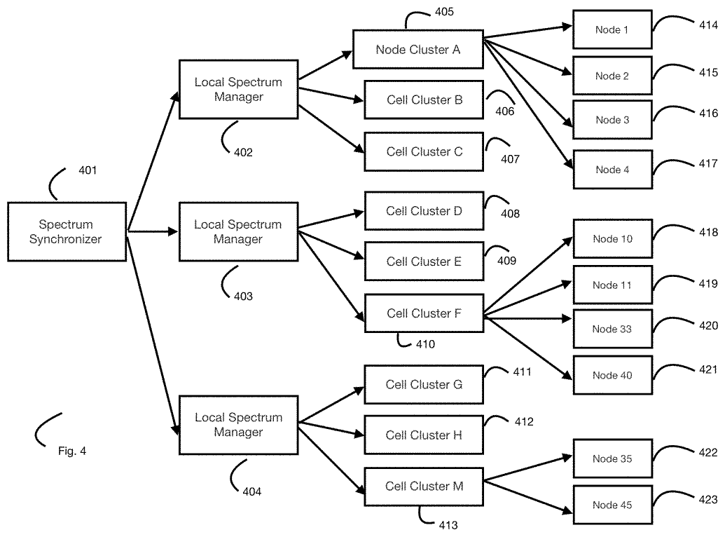

FIG. 5 shows node registration signaling flow, and procedures with local spectrum manager.

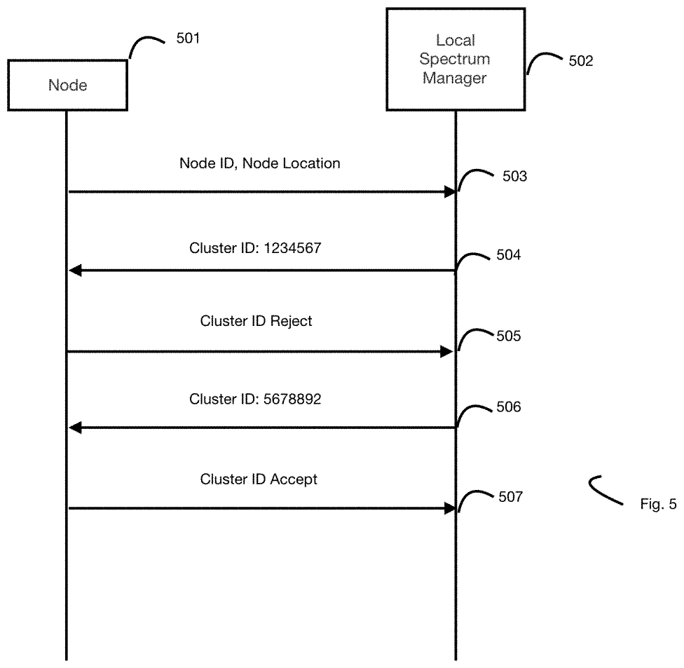

FIG. 6 shows signaling between node and local spectrum manager regarding node location, and node identification,

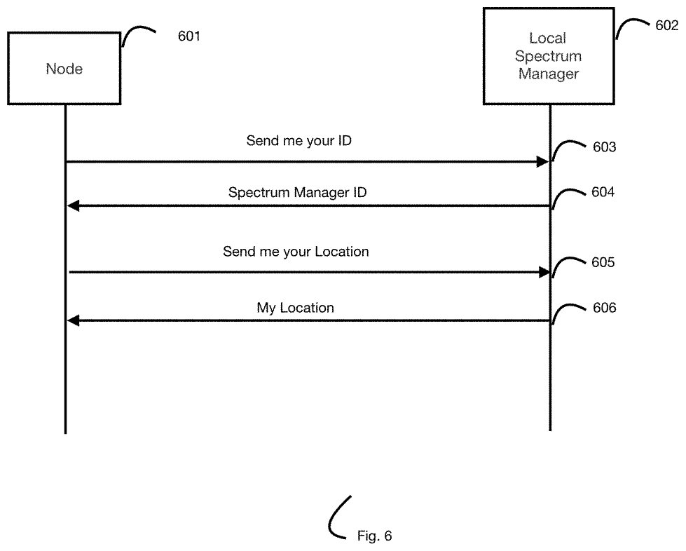

FIG. 7 shows node cluster mapping table consisting of nodes, node locations, node identifications, and cluster identifications,

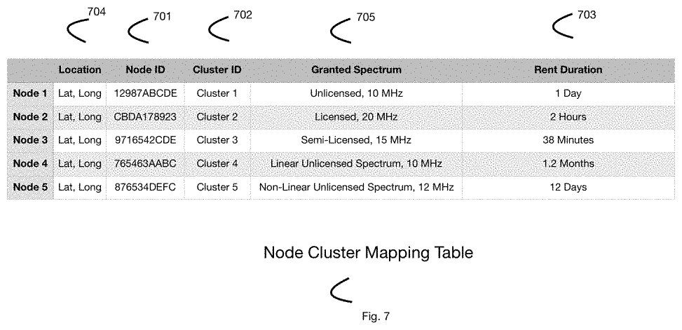

FIG. 8 shows node duster interference table consisting of node duster, interference level, number of nodes inside cluster, and the most interfering node in a duster.

FIG. 9 shows separate node and local spectrum manager deployment model,

FIG. 10 shows collocated node and local spectrum manager deployment model.

FIG. 11 shows hardware components of spectrum synchronizer.

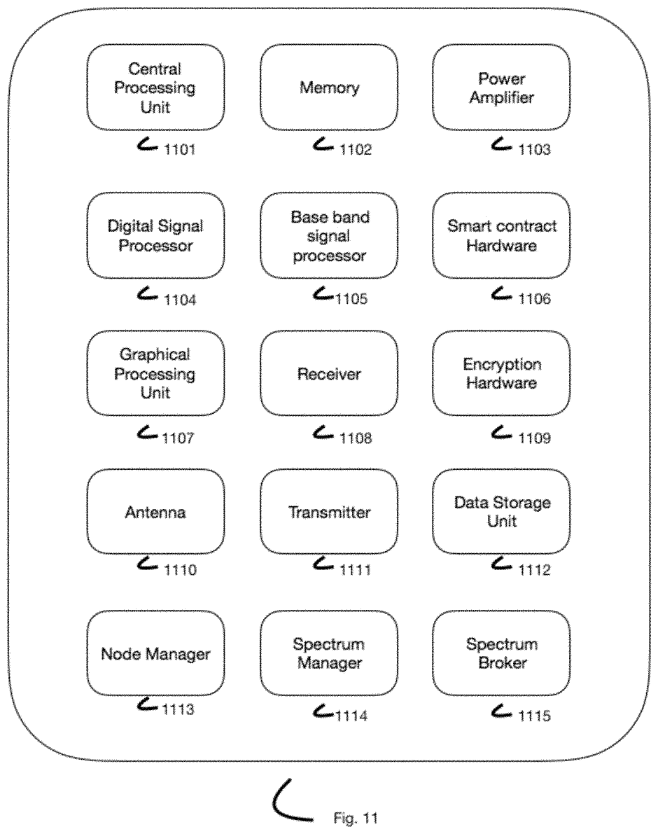

FIG. 12 shows hardware components of local spectrum manager.

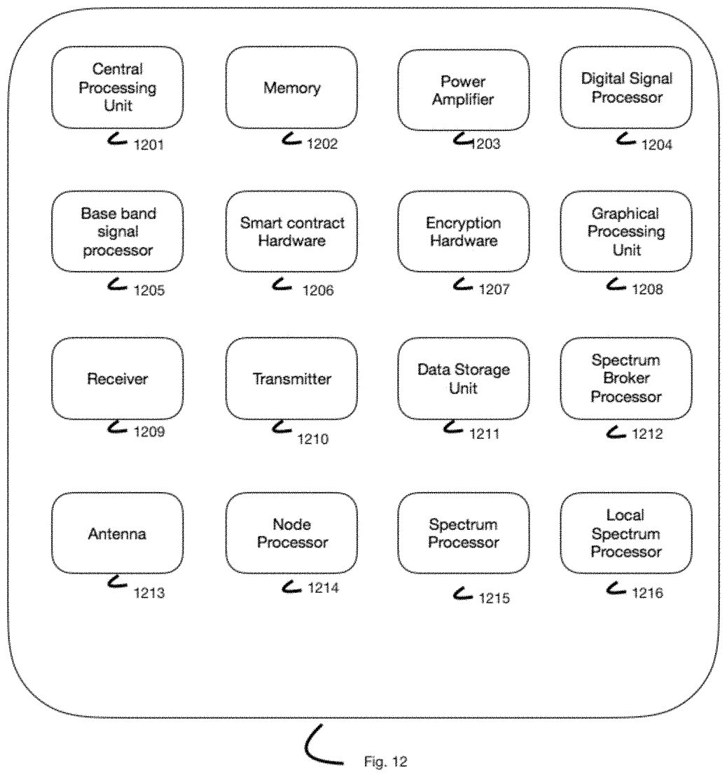

FIG. 13 shows connection among spectrum synchronizer and local spectrum managers.

FIG. 14 shows collocated local spectrum manager, spectrum synchronizer, and node deployment.

FIG. 15 shows local spectrum manager selection algorithm steps and flow.

FIG. 16 shows local spectrum manager selection algorithm steps and flow.

FIG. 17 shows local spectrum manager selection algorithm steps and flow.

FIG. 18 shows node connecting to a local spectrum manager at the shortest distance to itself.

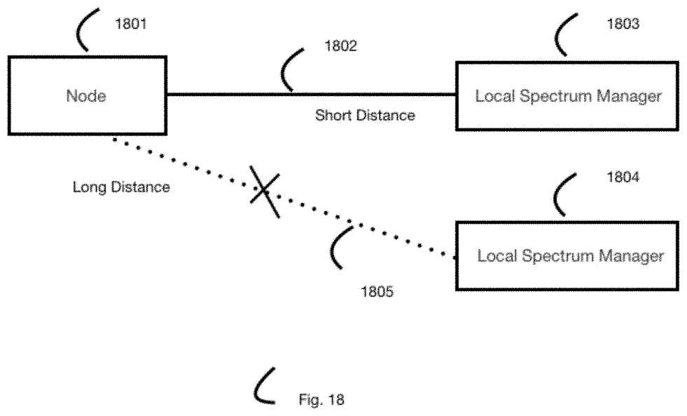

FIG. 19 shows node connecting to a local spectrum manager which has data communication link with the highest throughput capacity to itself,

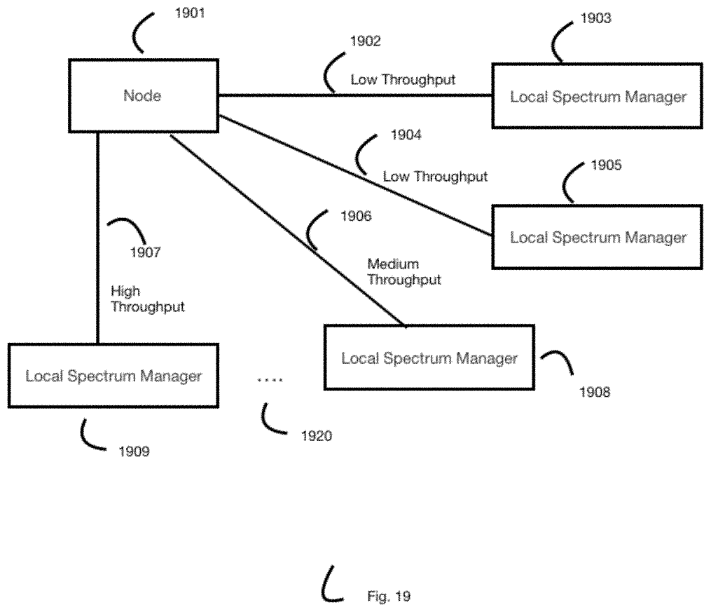

FIG. 20 shows node connecting to a local spectrum manager which has data communication link with the lowest data transmission delay to itself.

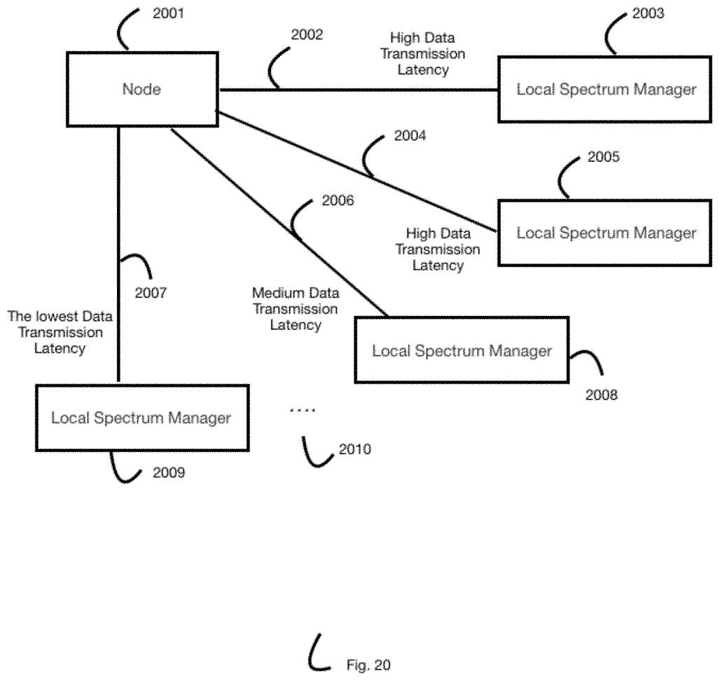

FIG. 21 shows node 1 connecting to node 2 to receive identification information for an LSM.

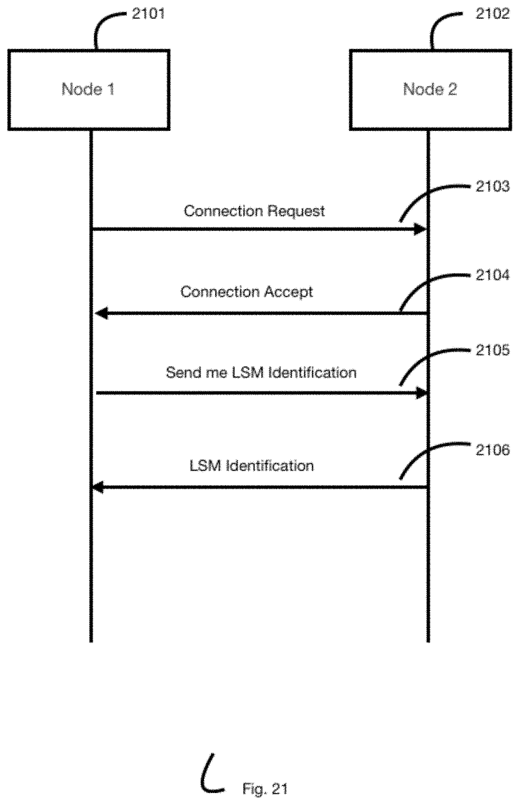

FIG. 22 shows node 1 connecting to local spectrum manager to receive identification information for all local spectrum managers in the network.

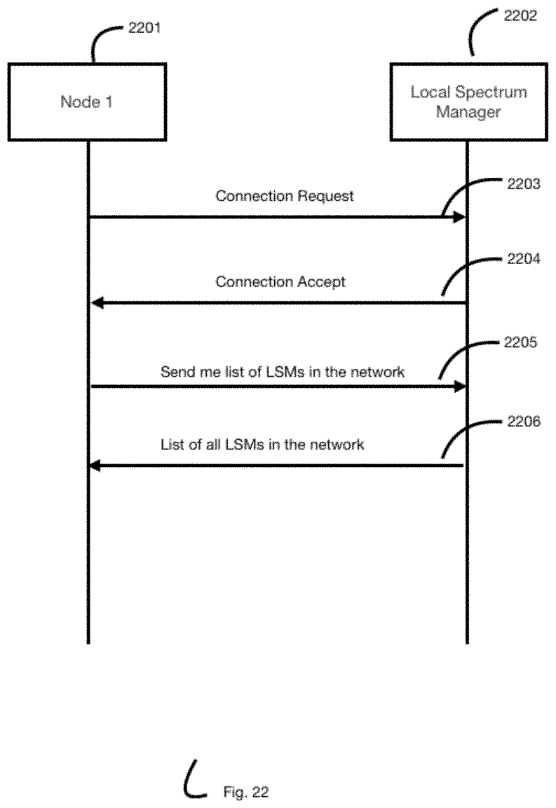

FIG. 23 shows local spectrum managers are connected to each other to learn about identification and other settings about each other.

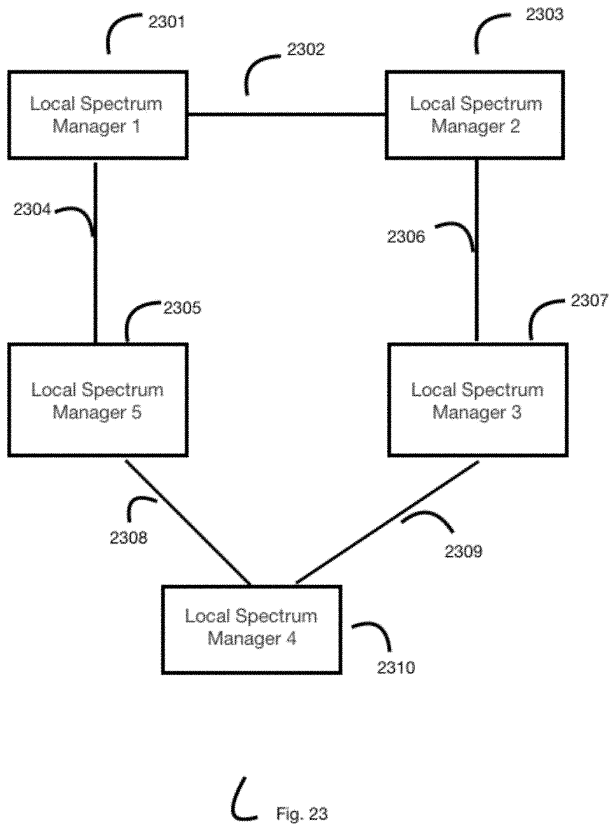

FIG. 24 shows the process of a node connecting to a different LSM than the one original connection request was sent.

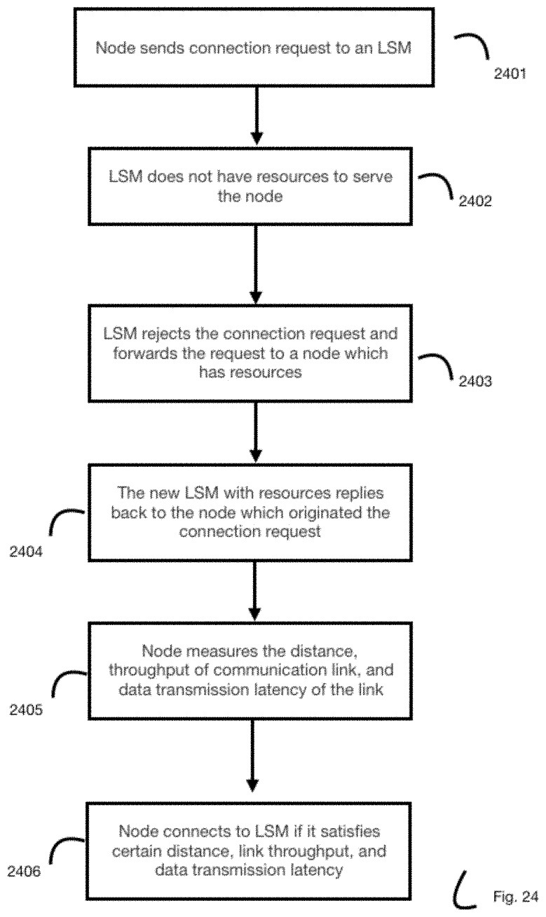

FIG. 25 shows the process of a node connecting to a different LSM than the one original connection request was sent.

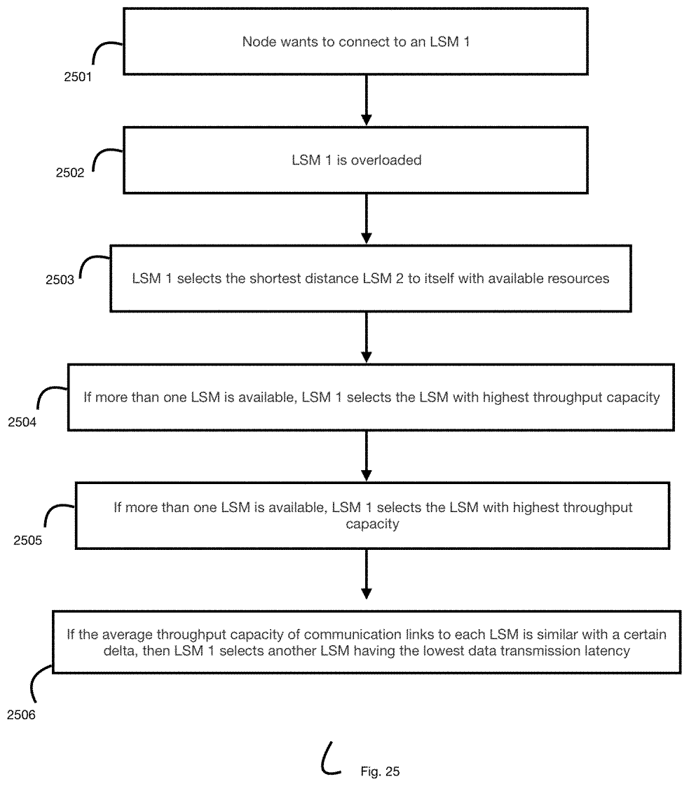

FIG. 26 shows the information exchange between local spectrum managers.

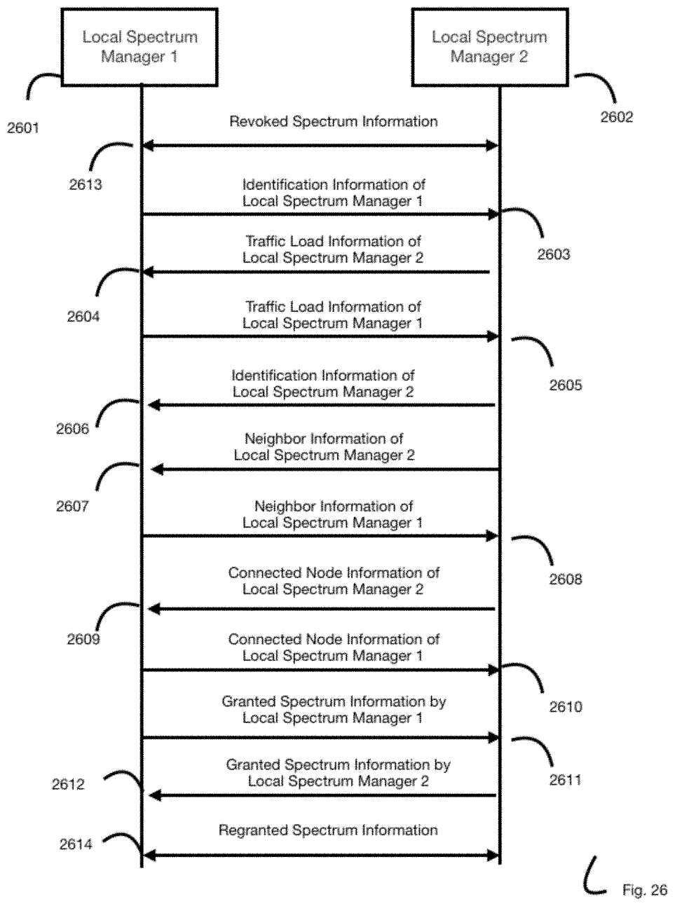

FIG. 27 shows the node coverage and node duster coverage,

### BRIEF SUMMARY OF THE INVENTION

Wireless communication network has many different types of nodes including, but not limited to; base stations, small base stations, smallcells, macrocells, microcells, access points, picocells, femtocells.

Wireless communication network uses different types of spectrum which are licensed, unlicensed, and semi-licensed. Licensed spectrum is a frequency spectrum assigned to a particular owner with a certain price for certain duration of time. Unlicensed spectrum is a frequency spectrum that is open to anyone who is interested using the spectrum. Semi-licensed spectrum is a frequency spectrum used as licensed spectrum at some locations, for some duration of time; and the same frequency spectrum is used as unlicensed spectrum for some duration of time and at some locations. Linear unlicensed spectrum has the same amount of frequency bands available to be used; and non-linear unlicensed spectrum has different amount of frequency bands available to be used. For example, in linear unlicensed spectrum band, any node requesting frequency band receives the same amount of spectrum, and for this example, we can say it is 20 MHz of spectrum band. So, each node in the network is granted 20 MHz of frequency spectrum when node asks for a frequency spectrum. In non-linear spectrum band, each node in the network is granted a different amount of spectrum. One node is granted 10 MHz of spectrum, and a different node is assigned 15 MHz of spectrum, another node is assigned 11.4 MHz of spectrum, etc. In this disclosure, spectrum, frequency spectrum, frequency band, spectrum band, frequency spectrum band terms are used interchangeably and these terms have the same meaning.

### DETAILED DESCRIPTION OF THE INVENTION

Node cluster 220, 211, 229 consists of more than one node, 201, 202, 203, 204, 205, 210, 211, 213, 214, 230, 232, 235, 236, 239. Each node is the cluster is connected to other nodes in the cluster. A user terminal 240, 241, 242, 243, 244, 245 is connected to a node to receive and transmit data packets or voice packets. Each node cluster is defined by a cluster ID. When a node is turned on; a node communicates with all local spectrum managers (LSM), 219, 222, 225 in the network, and selects the one that is nearest (the shortest distance) to itself, or a node selects the one that has fastest connection to itself, or a node selects the connection that has the lowest data transmission delay to itself or any combination of these criteria. Fastest connection means a link that has the highest throughput. Each node in the network knows internet protocol (IP) addresses of all LSMs in the network. Using this IP address, each node connects with local spectrum manager or local spectrum managers 219, 222, 225 in the network. LSMs are located at anywhere in the network, in the cluster, outside of the cluster, or outside of the network.

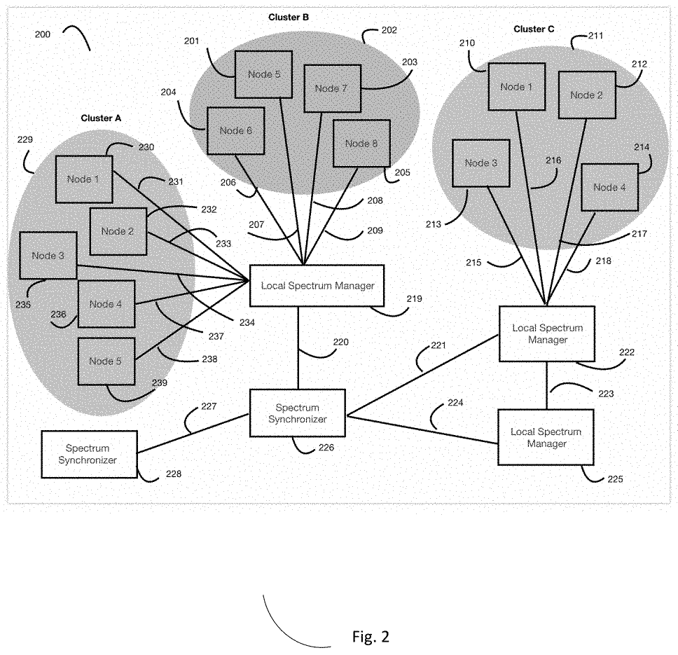

User terminal is connected to a node over a wireless link, 245, FIG. 2. A node connects to another node through communication medium, 231, 233, 234, 237, 238, 206, 207, 208, 209, 215, 216, 217, 218 which can be a wired link (cable link) or a wireless link, or any combination of both. A local spectrum manager connects to another local spectrum manager through communication medium 233, which can be a wired link (cable link) or a wireless link, or any combination of both. A local spectrum manager connects to a spectrum synchronizer through communication medium 220, 221, 224 which can be a wired link (cable link) or a wireless link, or any combination of both. A spectrum synchronizer connects to another spectrum synchronizer through communication medium 227, which can be a wired link (cable link) or a wireless link, or any combination of both.

When a node turns on, node connects to any other node in the network. Node receives Internet Protocol (IP) address of any LSM in the network from the node that is connected to. Node connects to that LSM using the IP address of that LSM. Node receives the list of all other LSMs in the network from that node. Node connects to an LSM based on at least one of;

Distance between itself and LSM,

Throughput capacity of communication link between itself and LSM,

Data Transmission latency of communication link between itself and LSM

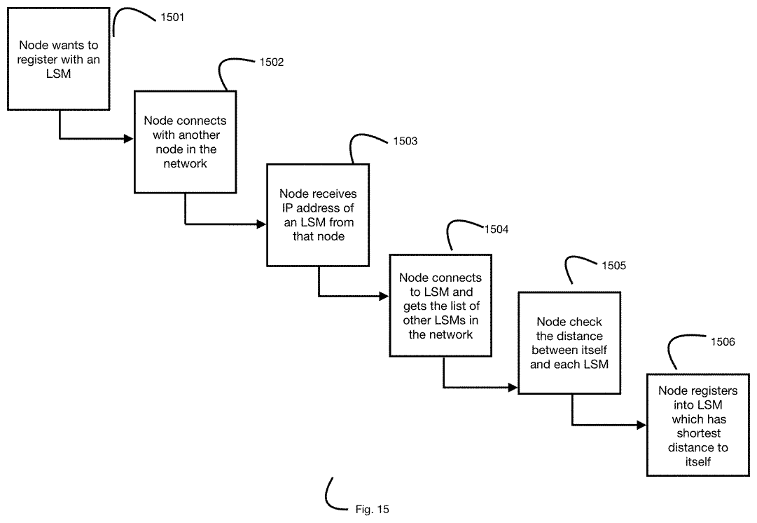

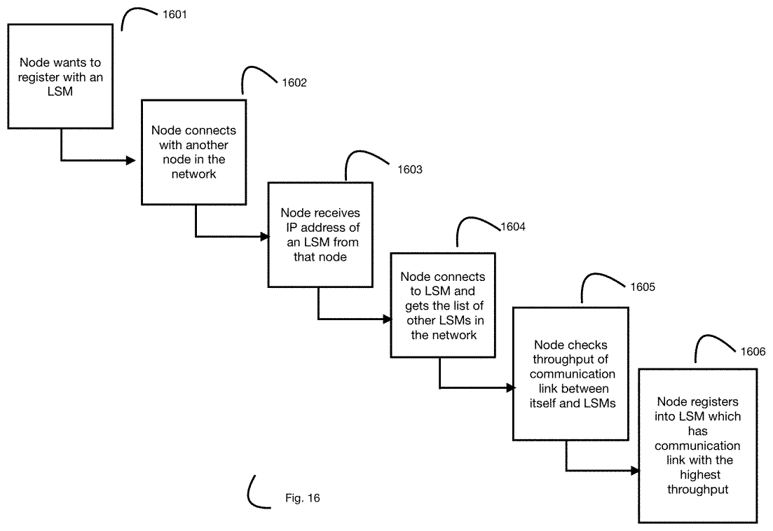

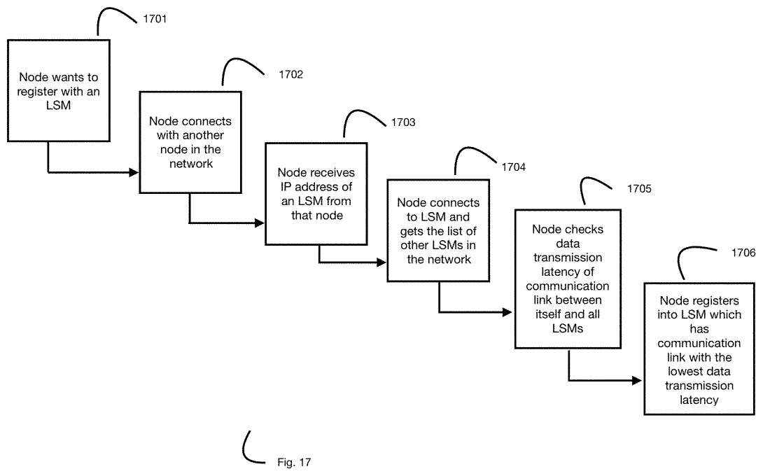

Node connects to an LSM which has the shortest distance to itself (FIG. 15). Node connects to an LSM which has the highest throughput capacity communication link to itself (FIG. 16). Node connects to an LSM which has the communication link with the lowest data transmission delay to itself (FIG. 17). Node connects to an LSM based on at least one of shortest distance, the highest communication link throughput, the lowest data transmission delay.

LSM is introduced in this disclosure. LSM assigns spectrum to each node in the node cluster that LSM is serving. LSM also assigns spectrum to a particular node cluster. Each node, 501 registers with LSM 502 based on the distance between a node and LSM, or based on the throughput and data latency performance of the link between a node and LSM, or any combination of these. Node registers with an LSM, if LSM has resources to serve the node. If LSM serves a node that is far away than a node wanting to register into LSM, LSM handovers this node to another LSM, and LSM accepts and serves new node. LSM knows how many nodes belong to a node cluster, and each node cluster has a cluster identification number (ID).

FIG. 15 shows process of connecting to an LSM in the network. First node wants to register with an LSM, 1501. This node is called originator node. Originator node connects with another node in the network 1502, and this node is any random node that can be connected. Originator node receives IP address of an LSM from the random node that it is connected to, 1503. Originator node connects to that LSM using LSM's IP address. Originator node receives the list of other LSMs in the network from the LSM that is it connected to, 1504. Originator node checks distance between itself and an LSM in the network, which is in the LSM list, 1505. Originator node registers with LSM which has the shortest distance to itself, 1506.

FIG. 16 shows process of connecting to an LSM in the network. First node wants to register with an LSM, 1601. We call this node originator node. Originator node connects with another node in the network 1602, and this node is any random node that can be connected. Originator node receives IP address of an LSM from the random node that it is connected to, 1603. Originator node connects to that LSM using LSM's IP address. Originator node receives the list of other LSMs in the network from the LSM that is it connected to, 1604. Originator node checks throughput of communication link between itself and an LSM in the network, which is in the LSM list, 1605. Originator node registers with LSM which has communication link with the highest throughput, 1606.

FIG. 17 shows process of connecting to an LSM in the network. First node wants to register with an LSM, 1701. We call this node originator node. Originator node connects with another node in the network 1702, and this node is any random node that can be connected. Originator node receives IP address of an LSM from the random node that it is connected to, 1703. Originator node connects to that LSM using LSM's IP address. Originator node receives the list of other LSMs in the network from the LSM that is it connected to, 1704. Originator node checks data transmission latency of each communication link between itself and an LSM in the network, which is in the LSM list, 1705. Originator node registers with LSM which has communication link with the lowest data transmission delay,1706.

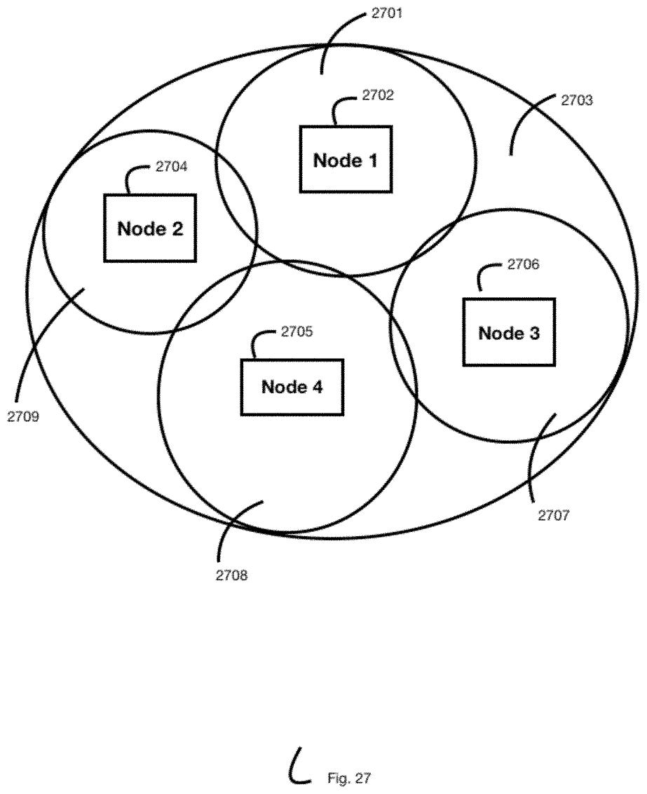

FIG. 27 shows the coverage of a node, and coverage of a node cluster. Node coverage 2701, 2709, 2708, 2707 means the furthest distance at where user can connect to a node, 2702, 2704, 2705, 2706. Node cluster coverage, 2703 means sum of coverage of nodes that constitute node cluster.

LSM assigns spectrum to a cluster using cluster ID, 504. LSM determines which node belongs to which cluster based on at least one of node location 605, 701, signal strength, and any other node and network parameter. Each node connecting to an LSM also tells its cluster ID where it is connected to. This is another way of knowing which node belongs to which cluster in the network. FIG. 700 shows node cluster mapping table that LSM holds for the whole network. This table has information of all nodes in the network. Table holds location, Node ID 503, 702 and Cluster ID, 504, 703 that a particular node belongs to. When the network topology changes, this table is also updated with information about the nodes.

LSM communicates assigned spectrum with Spectrum Synchronizer (SS), 301, 306. LSM 303, 304 knows all SSs in the network. SS knows all LSMs in the network. LSM to/from SS assignment is based on distance 300, throughput capacity of communication link between LSM and SS, and data transmission delay of communication link between LSM and SS. LSM 304 connects 305 to the nearest SS 306 and SS 301 connects to the nearest LSM 303.

SS, 401 manages the spectrum used in the whole network, and also the interference in the network. SS assigns and manages the spectrum based on at least one of the node cluster 405, 406, 407, 408, 409, 410, 411, 412, 413, distance of the clusters to each other, spectrum available, interference levels in the network. SS assigns different spectrum band to node clusters that are not far away from each other, and far away means the distance between node clusters is more than pre-defined threshold. SS assigns the same spectrum band to node clusters that are far away from each other. SS only assigns spectrum if there is unused frequency band available in the network. SS only assigns spectrum if the assignment of the spectrum does not cause interference to node clusters that are already up and running, that is, live node network. SS assigns only adequate spectrum to a particular cluster depending on at least one of;

Number of nodes in the cluster,

Backhaul type of each node,

Backhaul capacity of each node,

Total backhaul capacity of node cluster,

Wireless technology type node is running and wireless technology types can be 5G New radio, 5G Standalone deployment, 5G non-stand alone deployment, 4G long term evolution, 4G long term evolution advanced, 3G, 2G, Wifi,

Spectrum type; unlicensed, semi-licensed,

Interference levels,

Capacity requirement,

Number of user terminals and devices,

Latency requirement,

Traffic types consumed,

User terminal and device types,

Local spectrum manager location/number,

Node hardware capability and version,

Node software capability and version.

Each node in the cluster reports its own antenna power, reported signal strength from user equipment (UEs) in its coverage, reported signal-to-noise-plus-interference ratio from UEs in its coverage, number of UEs served, reported uplink signal transmission values from UEs in its coverage, reported bit error rate from UEs, reported block error rate from UEs, average amount of resources used in downlink and uplink, average downlink throughput, average uplink throughput.

LSM queries each node in the cluster to send certain power measurements, performance counters, key performance indicators, alarms, and other parameters to itself. When a node receives a query message from LSM, node responds the message in multiple ways. Node can say it is overloaded to handle additional work, and LSM query is an additional work for an overloaded node. Thus, node sends ‘overloaded now, re-try’ message back to LSM. Node can respond with ‘delayed reporting’ message with a field that says requested information will be delivered in ‘certain amount of time’ in the future. This ‘certain amount of time’ in given in seconds; and it can take any value starting from 1 second. For instance, if ‘certain amount of time’ is 120 seconds, then requested information will be sent to LSM in 120 seconds or 2 minutes.

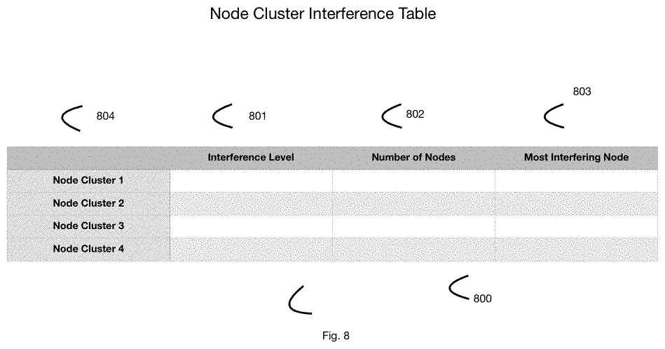

LSM calculates the interference for the node cluster or node clusters that it is serving. LSM has a node cluster interference table, 800 (FIG. 8) that holds the interference levels for each cluster and LSM ranks the clusters based on the interference levels 801. If LSM finds that a particular cluster's interference is higher than the other node clusters, 804, that it is serving, LSM can take any action to reduce that interreference to an acceptable level. One of the actions would be is to turn off the node, 802, that is making the largest contribution 803 to overall interference in a node cluster. In order to reduce interference, LSM can assign the same amount of frequency but in a different operating band or operating frequency.

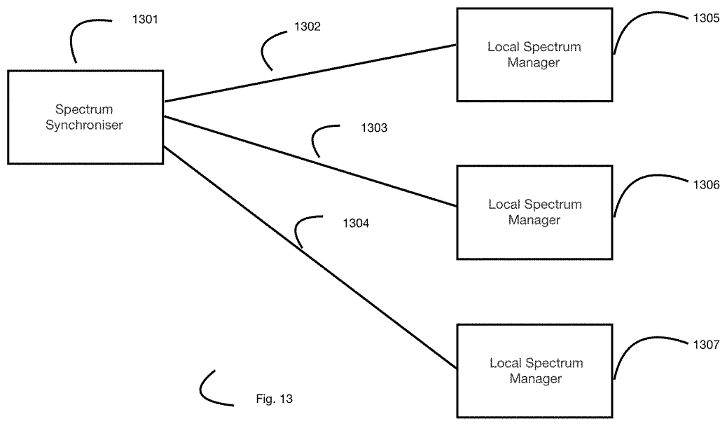

Each LSM, 1305, 1306, 1307 manages interference levels in all the node clusters that it is serving. Each LSM reports the interference values to SS, 1301 that it is connected to, FIG. 13. SS can connect to LSM through any type of communication interface, 1302, 1303, 1304 including wired, wireless, and any combination thereof. Each SS shares interference information with other SSs. In this way, all SSs can have the interference values in the whole network.

SS also determines if the available spectrum is licensed spectrum, unlicensed spectrum, or semi-licensed spectrum. If the spectrum is semi-licensed spectrum, SS knows which portion of the spectrum is licensed and which portion of the spectrum is un-licensed spectrum. For the unlicensed part of the spectrum, SS knows for which cluster, for how long the spectrum will be granted. SS knows interference levels in all licensed and unlicensed spectrum bands.

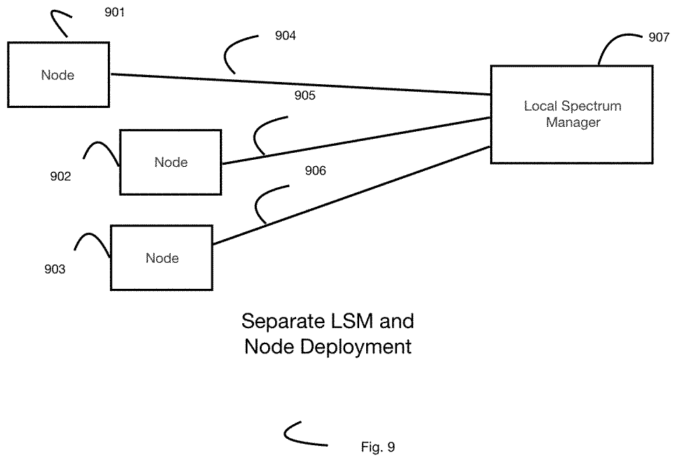

LSM, 907 and Node, 901, 902, 903 can be a separate entity, FIG. 9. For this case, LSM 907 is connected, 904, 905, 906 to a node, 901, 902, 903 through any type of wireless or wireless or any type of connectivity, 904, 905, 906. This is applicable for all link between a node and LSM, for a link between an LSM and SS, for a link between two LSMs, for a link between two SSs.

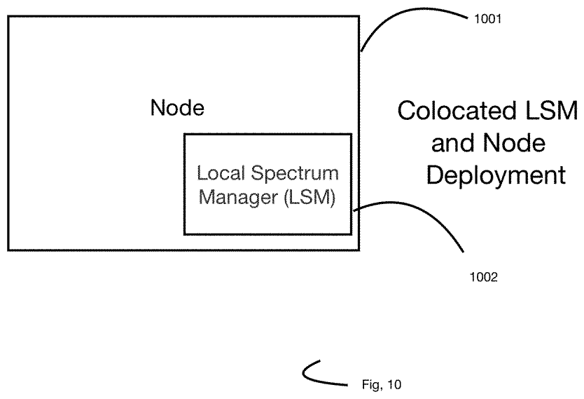

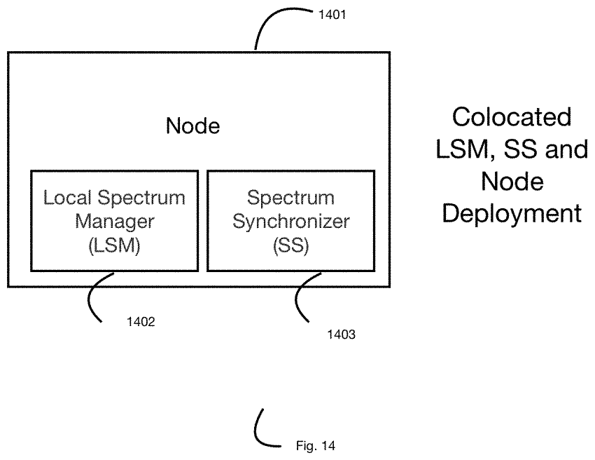

LSM, 1402 and SS, 1403 can located anywhere in the network; however they can also be located as part of a node, FIG. 14, 1400. LSM, 1002 can be also part of a node, 1001, FIG. 10.

1. A system comprising;
A local spectrum manager that grants spectrum to a node and or to a cluster of nodes;
A local spectrum manager that revokes the spectrum from a node and or from a cluster of nodes;
A spectrum synchronizer that manages of all used and unused frequency spectrum in a network;
A node providing data and voice services to a user terminal in a network;
A user terminal connecting to a node to receive and to transmit data and voice packets;
A local spectrum manager or local spectrum managers connecting to spectrum synchronizer(s) in the network;
A node connecting to another node in a network;
A node connecting to local spectrum manager in a network;
A node cluster consisting of at least one node;
A local spectrum manager connecting to other local spectrum managers in a network;
A local spectrum manager connecting to a spectrum synchronizer;
A spectrum synchronizer connecting to other spectrum synchronizers in a network;
communication links between a user equipment and a node, between nodes, between nodes and local spectrum managers, between local spectrum managers and spectrum synchronizers, and between spectrum synchronizers.

2. A method comprising;
granting, by a local spectrum manager, spectrum to a node in a node cluster;
holding, by a local spectrum manager, available spectrum information;
holding, by a local spectrum manager, granted spectrum information;
holding, by a local spectrum manager, revoked spectrum information;
holding, by a local spectrum manager, regranted spectrum information;
calculating, by a local spectrum manager, interference levels in the network;
communicating, by a local spectrum manager, granted spectrum list with spectrum synchronizer;
holding, by a local spectrum manager, node cluster mapping table;
holding, by a local spectrum manager, node cluster interference table;
requesting, by a local spectrum manager, certain performance measurement information from a node, from a group of nodes, from all nodes in a cluster;
revoking, by a local spectrum manager, already granted spectrum from a node, or from a node cluster;
regranting, by a local spectrum manager, spectrum to a node, or to a node cluster;
sending, by a node, identification information, cluster information to a local spectrum manager;
receiving, by a node, identification and location information of local spectrum manager;
connecting, by a node, to a local spectrum manager which has the shortest distance to a node requesting the connection;
connecting, by a node, to a local spectrum manager which has a communication link with the highest throughput to a node requesting the connection;
connecting, by a node, to a local spectrum manager which has a communication link with the lowest data transmission delay to a node requesting the connection;
connecting, by a local spectrum manager, to a spectrum synchronizer which has the shortest distance to a local spectrum manager requesting the connection;
connecting, by a local spectrum manager, to a spectrum synchronizer which has a communication link with the highest throughput to a local spectrum manager requesting the connection;
connecting, by a local spectrum manager, to a spectrum synchronizer which has a communication link with the lowest data transmission delay to a local spectrum manager requesting the connection;
receiving, by a spectrum synchronizer, spectrum information from a local spectrum manager, from a group of local spectrum managers, or all local spectrum managers in a network;
sharing, by a local spectrum manager, spectrum information with all other spectrum synchronizers in a network;
exchanging information, by a local spectrum manager, with other local spectrum managers;
revoking, by a spectrum synchronizer, granted spectrum to a local spectrum manager;
regranting, by a spectrum synchronizer, frequency spectrum to a local spectrum manager;
classifying, by a spectrum synchronizer, available frequency spectrum into unlicensed frequency spectrum, licensed frequency spectrum, semi-licensed frequency spectrum, linear unlicensed frequency spectrum, nonlinear unlicensed frequency spectrum;
determining, by a spectrum synchronizer, amount of available frequency;
managing, by a spectrum synchronizer, all interference in all frequency spectrum bands;
holding, by a spectrum synchronizer, spectrum management table having the list of all granted and free spectrum bands in a whole network;
assigning, by a spectrum synchronizer, spectrum band to local spectrum managers depending on at least one of traffic load in a node and in a node cluster, number of nodes connected to a local spectrum manager, interference level in a node cluster that local spectrum manager serves, received quality of service levels by user terminals in a node cluster, delivered quality of service levels by a node in a node cluster, type of wireless technology that is used by a node and a node cluster, type of a node, type of user terminals served by a node and by a node cluster, coverage of a node and a node cluster, targeted downlink capacity of a node and a node cluster, targeted uplink capacity of a node and a node cluster, backhaul capacity of a node and node cluster, type of frequency spectrum band, amount of frequency spectrum band, interference information about frequency spectrum band, utilization rate of frequency spectrum band, grant rate of frequency spectrum band, regrant rate of frequency spectrum band, revocation rate of frequency spectrum band.

3. In claim 2 wherein said granting the spectrum consists of a node or nodes in the network registering with the nearest local spectrum manager, or registering with the local spectrum manager that has the fastest communication link to itself, or registering with the local spectrum manager that has the lowest delay communication link to itself, or any combination thereof, and assigning frequency spectrum to a node or a cluster of nodes in a network.

4. In claim 2 wherein said calculating the interference levels consist of at least one of collecting signal strength values, signal-to-noise-plus-interference ratio values, number of user terminals, uplink signal transmission power values, bit error rate values, average amount of resources used in downlink, average amount of resources used in uplink, average downlink throughput values, average uplink throughput values, block error rate values reported by nodes in the clusters, and calculating signal interference experienced by a node and total interference in a node cluster.

5. In claim 2 wherein said calculating the interference values consists of local spectrum manager sending queries to each node in a node cluster.

6. In the method of claim 5 wherein said querying a node consists of each node in a node cluster sending at least one of signal power measurements, node performance counters, node key performance indicators, node alarms, node settings, node parameters to local spectrum manager.

7. In the method of claim 5 wherein said querying a node further consists of a node responding to a query with one of multiple states, which are overloaded state, delayed reporting state.

8. In claim 7 wherein said overloaded state further means that a node is overloaded to handle additional work, and a node responds with ‘overloaded, re-try’ message back to local spectrum manager.

9. In claim 7 wherein said delayed reporting state further means that node will respond with ‘delayed reporting’ message with a field that says requested information will be delivered in some determined ‘certain amount of time’ in the future.

10. In claim 2 wherein said holding spectrum information consists of creating a node cluster mapping table that holds information of all nodes, node locations, node identifications, node cluster identifications, granted spectrum to each node, granted spectrum to each node cluster, duration of granted spectrum, type of spectrum.

11. In claim 2 wherein said local spectrum manager communicating granted spectrum with spectrum synchronizer further consisting of local spectrum manager knowing all spectrum synchronizers in an entire network, and local spectrum manager registering with spectrum synchronizer based on at least one criteria of the nearest spectrum synchronizer, spectrum synchronizer that has the fastest communication link to local spectrum manager, spectrum synchronizer that has the lowest delay communication link to local spectrum manager.

12. In claim 2 wherein said communicating with local spectrum manager consists of a node knowing all local spectrum managers in an entire network, and a node registering with local spectrum manager based on at least one criteria of the nearest local spectrum manager, local spectrum manager that has the communication link with the highest throughput, local spectrum manager that has the communication link with the lowest data transmission delay.

13. In claim 2 wherein said determining spectrum characteristics consist of determining the amount of total available licensed spectrum, amount of total available unlicensed spectrum, amount of total available semi-licensed spectrum, amount of total available linear unlicensed spectrum, amount of total available non-linear unlicensed spectrum in a network.

14. In claim 2 wherein said holding the list of granted and free spectrum consists of a table that shows the local spectrum managers registered and connected with spectrum synchronizer.

15. In claim 2 wherein said managing the interference consisting at least one of receiving interference reports from local spectrum managers, finding root cause of interference, sharing interference information with other spectrum synchronizers in the network, lowering interference to acceptable levels, powering up a node, powering up a group of nodes, powering up a node cluster, powering down a node, powering down a group of nodes, powering down a node cluster, turning on a node, turning on a group of nodes, turning on a node cluster, turning down a node, turning down a group of nodes, turning down a node cluster.

16. In claim 2 wherein said licensed frequency spectrum further means amount of spectrum that is licensed to individuals, businesses, government organizations and any institutions.

17. In claim 2 wherein said unlicensed frequency spectrum further means amount of spectrum that can be used by anyone for some amount of time determined by nodes, node clusters and spectrum synchronizers in the network.

18. In claim 2 wherein said semi-licensed frequency spectrum further means an amount of spectrum that is licensed at some locations, and unlicensed at some locations in the network.

19. In claim 2 wherein said linear unlicensed frequency spectrum means an amount of spectrum that can be granted is the same size in the entire unlicensed spectrum band.

20. In claim 2 wherein said non-linear unlicensed frequency spectrum means an amount of spectrum that can be granted is not fixed size in the entire unlicensed spectrum band.

21. In claim 1 wherein said user equipment further means mobile device, user terminal, test terminal, smart watch, watch, laptop computer, desktop computer, television, smart television, television, mobile phone, smart phone, virtual reality handset, virtual reality device, virtual reality headset, sensor, augmented reality device, augmented reality headset, wearables, wearable device, health sensor inside and outside of an organism including human beings.

22. In claim 2 wherein said type of a node further means a microcell base station, a smallcell base station, a wifi access point, a satellite dish, a satellite node, a satellite ground station, a macro base station, a femtocell base station, a bluetooth node, a bluetooth base station, a wireless node.

23. In claim 2 wherein said traffic load further means the percentage of overall node and node cluster capacity used to transmit downlink traffic to user terminals and to receive uplink traffic from user terminals.

24. In claim 2 wherein said received quality of service further means checking the quality of delivered data packets and voice packets against pre-defined levels of bit error rate, data latency, block error rate, signal power level, minimum bit error rate, guaranteed bit error rate, mean opinion score, voice quality score, video quality score.

25. In claim 2 wherein said node coverage and cluster coverage further means the maximum distance from the site where user terminal can connect to a node or to any node which is part of the same node cluster.

26. In claim 2 wherein said utilization of frequency spectrum band further means how much a particular spectrum band is used by a node, or by a node cluster.

27. In claim 2 wherein said grant rate of frequency spectrum further means how many times a particular spectrum band is granted to a node or to a node cluster during a specified time duration.

28. In claim 2 wherein said regrant rate of frequency spectrum band further means how many times a particular spectrum band is regranted to a node or to a node cluster during a specified time duration.

29. In claim 2 wherein said revocation rate of frequency spectrum band further means how many times a particular spectrum band is revoked during a specified time duration.

30. In claim 2 wherein said backhaul capacity further means number of bits that can be transmitted over backhaul connection in a second.

31. In claim 2 wherein said type of wireless communication further means third generation (3G) wireless communication system, fourth generation (4G) wireless communication system, fifth generation (5G) wireless communication system, sixth generation (6G) wireless communication, satellite communication system, wifi communication system, Bluetooth communication system, and any wireless communication system.

32. In claim 2 wherein said exchanging information consists of exchanging at least one of identification information, traffic local information, neighbor local spectrum manager information, connected node information, granted spectrum information, regranted spectrum information, revoked spectrum information.
